(19) United States
(12) Patent Application Publication
(10) Pub. No.: US 2025/0392372 A1
(43) Pub. Date: Dec. 25, 2025

(54) COMMUNICATION APPARATUS AND COMMUNICATION METHOD USING MULTIPLE WIRELESS COMMUNICATION SYSTEMS

(71) Applicant: JVCKENWOOD Corporation, Yokohama-shi (JP)

(72) Inventor: Yuki MIYAZAKI, Yokohama-shi (JP)

(21) Appl. No.: 19/316,202

(22) Filed: Sep. 2, 2025

Related U.S. Application Data
(63) Continuation of application No. PCT/JP2024/003241, filed on Feb. 1, 2024.

(30) Foreign Application Priority Data
Mar. 3, 2023 (JP) 2023-032992

(51) Int. Cl. H04B 7/15; H04B 17/318

(52) U.S. Cl. CPC H04B 7/15; H04B 17/318

(57) ABSTRACT

A relay quality acquirer acquires, as first relay quality information, a communication state between a first base station apparatus and a first communication terminal and acquires, as second relay quality information, a communication state between a second base station apparatus and a second communication terminal. An evaluation value calculator calculates a first evaluation value and a second evaluation value based on the first relay quality information, the second quality information, and the evaluation coefficient stored in the storage. A selector selects one of the first communication terminal and the second communication terminal as a prioritized terminal by using the first evaluation value and the second evaluation value.

### CROSS-REFERENCE TO RELATED APPLICATION

This application is based upon and claims the benefit of priority from the prior Japanese Patent Application No. 2023-032992, filed on Mar. 3, 2023, the entire contents of which is incorporated herein by reference.

### BACKGROUND

### 1. Technical Field

The present disclosure relates to communication technology and, in particular, to a communication apparatus and a communication method that use multiple wireless communication systems.

### 2. Description of the Related Art

The PTT (Push to Talk) function is a function that provides users with the same usability as half-duplex wireless equipment. Users can simply press the call button to call and speak to multiple other users without entering a phone number, etc. Other users do not have to press the answer button to have the speech output from that other user's mobile phone. The PTT function in a mobile phone is also called the PoC (Push-to-Talk over Cellular) in distinction from the PTT function of business wireless equipment. Meanwhile, a hybrid terminal equipped with the functions of both a mobile phone and a business wireless equipment is possible. In a hybrid equipment, the PoC function in a communication network of mobile phones like LTE and the PTT function in a communication network of business wireless equipment are used for different purposes (e.g., Patent Literature 1).

[Patent Literature 1] JP2016-139952.

Conventionally, a hybrid terminal equipped with the functions of business wireless equipment and PoC terminals are configured on an assumption that the terminal is connected to a server configured for a communication scheme that complies to the specification presumed by the product or adapted for communication with the terminal. When the user attempts to exploit the business wireless equipment and the PoC system available for operation, therefore, the hybrid terminal might not be used properly due to a difference in the specifications.

### SUMMARY

A communication apparatus according to an embodiment is a communication apparatus adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, and includes: a communicator that communicates with the first communication terminal and the second communication terminal; a relay quality information acquirer that acquires, as first relay quality information, a communication state between the first base station apparatus and the first communication terminal and acquires, as second relay quality information, a communication state between the second base station apparatus and the second communication terminal; a storage that stores an evaluation coefficient related to the first relay quality information and the second relay quality information; an evaluation value calculator that calculates a first evaluation value and a second evaluation value based on the first relay quality information, the second relay quality information, and the evaluation coefficient stored in the storage; a selector that selects, as a prioritized terminal, one of the first communication terminal and the second communication terminal by using the first evaluation value and the second evaluation value; and a controller that controls an audio signal from the prioritized terminal to be reproduced when the audio signal from the prioritized terminal changes from a silent state to an audible state within a predetermined period of time since an audio signal from a non-prioritized terminal changes from a silent state to an audible state.

Another embodiment also relates to a communication apparatus. The apparatus is a communication apparatus adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, and includes: a communicator that communicates with the first communication terminal and the second communication terminal by a third wireless communication scheme; a relay quality information acquirer that acquires first route quality information from a communication state between the first communication terminal and the communicator and a communication state between the first base station apparatus and the first communication terminal and that acquires second route quality information from a communication state between the second communication terminal and the communicator and a communication state between the second base station apparatus and the second communication terminal; a storage that stores an evaluation coefficient related to the first route quality information and the second route quality information; an evaluation value calculator that calculates a first evaluation value and a second evaluation value based on the first route quality information, the second route quality information, and the evaluation coefficient stored in the storage; a selector that selects, as a prioritized terminal, one of the first communication terminal and the second communication terminal by using the first evaluation value and the second evaluation value; and a controller that controls an audio signal from the prioritized terminal to be reproduced when the audio signal from the prioritized terminal changes from a silent state to an audible state within a predetermined period of time since an audio signal from a non-prioritized terminal changes from a silent state to an audible state.

Still another embodiment also relates to a communication method. The method is a communication method adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, and includes: acquiring, as first relay quality information, a communication state between the first base station apparatus and the first communication terminal and acquires, as second relay quality information, a communication state between the second base station apparatus and the second communication terminal, wherein an evaluation coefficient related to the first relay quality information and the second relay quality information is stored in a storage, the method further including: calculating a first evaluation value and a second evaluation value based on the first relay quality information, the second relay quality information, and the evaluation coefficient stored in the storage; selecting, as a prioritized terminal, one of the first communication terminal and the second communication terminal by using the first evaluation value and the second evaluation value; and controlling an audio signal from the prioritized terminal to be reproduced when the audio signal from the prioritized terminal changes from a silent state to an audible state within a predetermined period of time since an audio signal from a non-prioritized terminal changes from a silent state to an audible state.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a configuration including a first wireless communication system and a second wireless communication system according to an exemplary embodiment;

FIG. 2 shows a configuration of the communication apparatus of FIG. 1;

FIG. 3 shows a data structure of a database stored in the storage of FIG. 2;

FIG. 4 shows a data structure of a parameter table stored in the storage of FIG. 2;

FIG. 5 shows a configuration of the controller of FIG. 2;

FIG. 6 is a flowchart showing a sequence of steps performed by the controller of FIG. 5 to determine a prioritized terminal;

FIG. 7 is a flowchart showing a sequence of steps performed by the controller of FIG. 5 to derive a relay quality;

FIG. 8 is a flow chart showing a sequence of steps performed by the controller of FIG. 5 to derive a connection quality;

FIG. 9 shows another data structure of the parameter table stored in the storage of FIG. 2;

FIG. 10 is a flowchart showing a sequence of steps performed by the controller of FIG. 5 to derive the evaluation value;

FIG. 11 is a flowchart showing a sequence of steps for transmission by the communication apparatus of FIG. 2;

FIG. 12 shows an overview of a reception process by the communication apparatus of FIG. 2;

FIG. 13 shows an overview of another reception process by the communication apparatus of FIG. 2;

FIG. 14 shows another configuration of the controller of FIG. 2;

FIG. 15 is a flowchart showing a sequence of steps of the readout process of FIG. 14; and

FIG. 16 is a flowchart showing a sequence of steps of the reproduction process of FIG. 14.

### DETAILED DESCRIPTION

The invention will now be described by reference to the preferred embodiments. This does not intend to limit the scope of the present invention, but to exemplify the invention.

A summary will be given before describing an exemplary embodiment in specific details. The exemplary embodiment relates to a communication apparatus connected to a communication terminal that complies with multiple types of wireless communication methods, respectively. The communication apparatus is an apparatus equipped with a speaker, a microphone, and a PTT button, and capable of calling via the multiple communication terminals connected. One of the multiple communication terminals is a smartphone that runs a PoC application. Another of the multiple communication terminals is a business wireless equipment piece equipped with a PTT button. Hereinafter, business wireless equipment may also be referred to as wireless equipment. The communication apparatus selects the most suitable communication terminal when the PTT button is pressed and transmits an audio signal, or selectively reproduces an audio signal received from multiple communication terminals, while checking the state of communication connection with each communication terminal and the state of communication with the base station apparatus. The communication state represents the quality of communication. In the following, (1) an overview of the system, (2) a process of determining a prioritized terminal, (3) a transmission process, and (4) a reception process will be described in the stated order.

### (1) Overview of the System

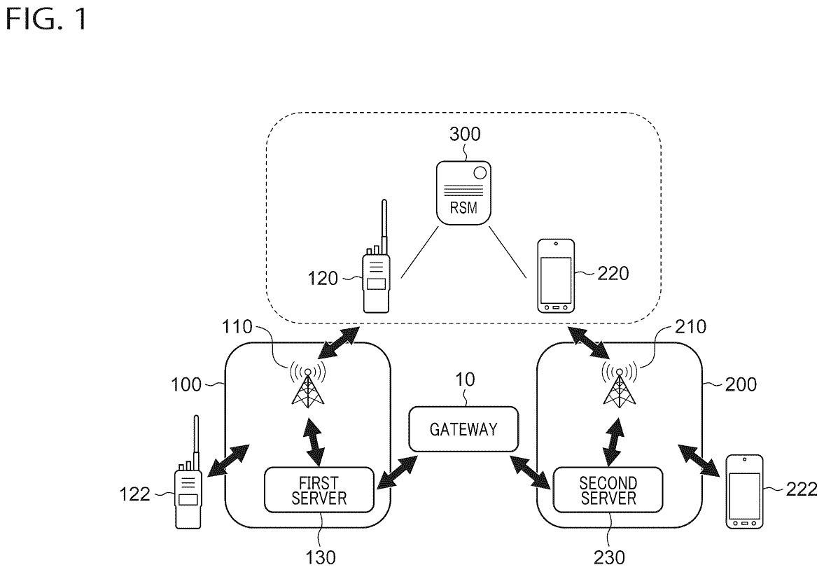

FIG. 1 shows a configuration including a first wireless communication system 100 and a second wireless communication system 200. The first wireless communication system 100 includes a first base station apparatus 110, a first communication terminal 120, a first communication terminal 122, and a first server 130, and the second wireless communication system 200 includes a second base station apparatus 210, a second communication terminal 220, a second communication terminal 222, and a second server 230. The number of first base station apparatuses 110 and the number of first servers 130 included in the first wireless communication system 100 are not limited to “1”, and the number of first communication terminals (the first communication terminal 120, the first communication terminal 122) included in the first wireless communication system 100 is not limited to “2”. The number of second base station apparatuses 210 and the number of second servers 230 included in the second wireless communication system 200 are not limited to “1”, and the number of second communication terminals (the second communication terminal 220, the second communication terminal 222) included in the second wireless communication system 200 is not limited to “2”.

The first wireless communication system 100 is, for example, a business wireless system and performs communication between the first base station apparatus 110 and the first communication terminal 120 (the first communication terminal 122) by the business wireless communication scheme. The first server 130 is a server used in the first wireless communication system 100. The second wireless communication system 200 is a PoC system that uses the data communication function of a mobile phone system such as LTE (Long Term Evolution) and performs, for example, communication between the second base station apparatus 210 and the second communication terminal 220 (the second communication terminal 222) by the mobile phone wireless communication scheme. The second communication terminal 220 (the second communication terminal 222) runs the PoC application. The second server 230 is a server used in the second wireless communication system 200. Given that the wireless communication scheme in the first wireless communication system 100 is referred to as the first wireless communication scheme, the wireless communication scheme in the second wireless communication system 200 is referred to as the second wireless communication scheme. The first and second radio communication schemes are different from each other.

A gateway 10 is connected to the first server 130 and the second server 230 to perform protocol conversion between the first wireless communication system 100 and the second wireless communication system 200. When the gateway 10 receives an audio signal from the first server 130 compliant with the protocol of the first wireless communication system 100, for example, the gateway 10 converts the audio signal into a signal compliant with the protocol of the second wireless communication system 200 and transmits the converted audio signal to the second server 230. Further, when the gateway 10 receives an audio signal compliant with the protocol of the second wireless communication system 200 from the second server 230, the gateway 10 converts the audio signal into a signal compliant with the protocol of the first wireless communication system 100 and transmits the converted audio signal to the first server 130. The gateway 10 configured like this transfers the audio signal retaining the same content between the first wireless communication system 100 and the second wireless communication system 200.

A communication apparatus 300 is capable of communicating with the first communication terminal 120 (the first communication terminal 122) and the second communication terminal 220 (the second communication terminal 222) by, for example, a near-field wireless communication system such as Bluetooth (registered trademark). The wireless communication scheme in the near-field wireless communication system is also referred to as the third wireless communication scheme. The third wireless communication scheme is different from the first wireless communication scheme and the second wireless communication scheme. The user uses the communication apparatus 300 to perform audio communication by the first wireless communication system 100 through the first communication terminal 120 or perform audio communication by the second wireless communication system 200 through the second communication terminal 220.

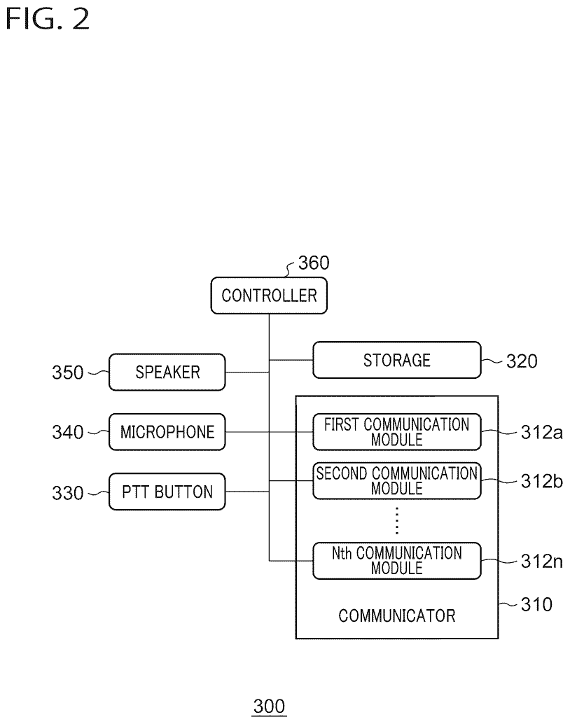

FIG. 2 shows a configuration of the communication apparatus 300. The communication apparatus 300 includes a communicator 310, a storage 320, a PTT button 330, a microphone 340, a speaker 350, and a controller 360. The communicator 310 includes a first communication module 312a, a second communication module 312b, and an Nth communication module 312n, collectively referred to as a communication module 312.

The plurality of communication modules 312 are each compliant with the near-field wireless communication system and perform communication with the first communication terminal 120 (the first communication terminal 122), the second communication terminal 220 (the second communication terminal 222), etc. of FIG. 1 by the third wireless communication scheme. For example, the first communication module 312a communicates with the first communication terminal 120, and the second communication module 312b communicates with the second communication terminal 220. The first communication module 312a is connected to the first communication terminal 120 by pairing with the first communication terminal 120. Further, the second communication module 312b is connected to the second communication terminal 220 by pairing with the second communication terminal 220 and communicates with an application of the second communication terminal 220. The first communication module 312a periodically attempts to connect to and communicate with the first communication terminal 120 and stores the resultant connection and communication state in the storage 320. The second communication module 312b, etc. also performs a similar process. The operation of these communication modules 312 is controlled by the controller 360.

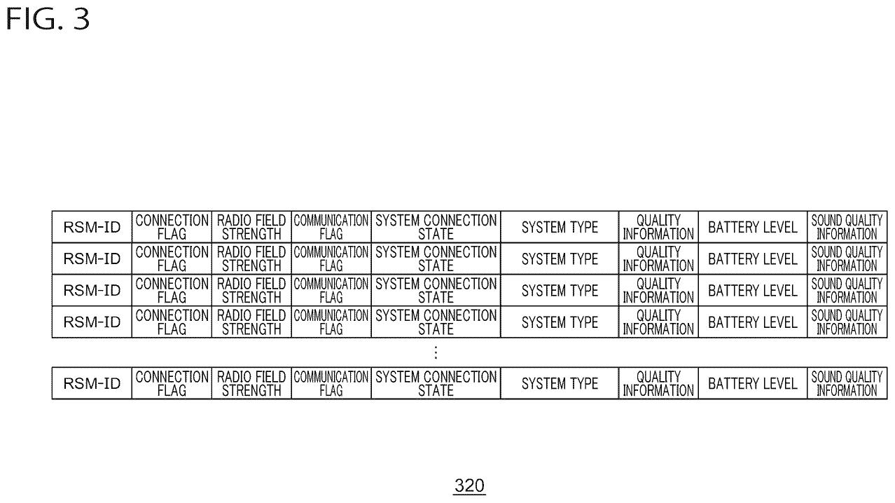

FIG. 3 shows a data structure of a database stored in the storage 320. RSM-ID is identification information used to identify each communication module 312. “Connection FLAG” is information that indicates whether the communication module 312 is connected to the communication terminal by the third wireless communication scheme. When connection is established, “Connection FLAG” indicates OK. If not, “Connection FLAG” indicates NG. “Radio field strength” (ICn) indicates the strength of connection between the communication module 312 and the communication terminal by the third wireless communication scheme. For example, “XdBm” is entered in the field.

“Communication FLAG” is information that indicates whether the communication module 312 successfully connected to the communication terminal can communicate with a program running in the communication terminal. When communication is successful, “Communication FLAG” indicates OK. If communication fails, “Communication FLAG” indicates NG. “System connection state” is information that indicates whether the program running in the communication terminal is connected to the communication system used for communication. When the program is connected, “System connection state” indicates that the system is being connected. If not, “System connection state” indicates that the system is not connected. “System type” is information related to the type of the communication system used by the communication terminal. “System type” indicates, for example, PoC, LMR. “Quality information” (IQn) indicates the quality between the communication terminal and the base station apparatus. “Battery level” indicates the battery level that remains in each communication terminal. “Battery level” indicates, for example, “Y %”, “Z hours remaining”. “Sound quality information” indicates the sound quality level of the communication system. “Sound quality information” is indicates, for example, “LOW”, “MID”, and “HIGH”. “Communication FLAG”, “System connection state”, “System type”, “Quality Information” (IQn), and “Sound quality Information” are provided by the communication terminal in response to a request from the communication apparatus 300 to the communication terminal. Reference is made back to FIG. 2.

The PTT button 330 is a button that can be pressed down by the user. The PTT button 330 is an interface manipulated by the user using the communication apparatus 300. The PTT button 330 outputs the received user operation to the controller 360. While the PTT button 330 is being pressed down, one of the communication modules 312 can transmit an audio signal. When the PTT button 330 is not being pressed down, on the other hand, each communication module 312 can receive an audio signal.

The microphone 340 acquires the sound originated by the user when the user presses down the PTT button 330. The microphone 340 converts the acquired sound into an electrical signal and outputs the converted sound (hereinafter referred to as “audio signal”) to the controller 360. When the user does not press down the PTT button, the controller 360 receives an audio signal from one of the communication modules 312 and converts the audio signal into sound before outputting the sound. This audio signal is an audio signal included in a signal received by one of the communication modules 312 from a further communication terminal. The controller 360 controls the operation of the communication apparatus 300.

### (2) Process for Determining a Prioritized Terminal

In the following, it is assumed, for the sake of clarity of the explanation, that the first communication module 312a can communicate with the first communication terminal 120, and the second communication module 312b can communicate with the second communication terminal 220. To describe it specifically, either the first communication module 312a or the second communication module 312b transmits an audio signal to the communication terminal, and either the first communication module 312a or the second communication module 312b receives an audio signal from the communication terminal. Of the multiple communication terminals, the communication terminal that should be used preferentially for transmission and reception of audio signals is referred to as a “prioritized terminal”. In addition, the communication terminal, of the multiple communication terminals, other than the prioritized terminal is referred to as a “non-prioritized terminal”. The prioritized terminal is a communication state preferentially used for communication because of a good communication state determined by comparing the communication state on the side of the first communication terminal 120 and the communication state on the side of the second communication terminal 220. The communication state is evaluated by the evaluation value determined from the connection quality and the relay quality, which will be described later, and the prioritized terminal is determined accordingly. Based on the evaluation value of the communication state, the prioritized terminal is determined as the case arises, and the audio signal is transmitted and received accordingly. When the audio signal is transmitted, the audio signal is transmitted to the prioritized terminal determined as the case arises. This ensures that the communication terminal with a good communication state and a high possibility of delivering the audio signal properly is selected and that the audio signal is delivered to the target of communication reliably. When the audio signal is received, the audio signal arriving from the prioritized terminal determined as the case arises is controlled to be reproduced preferentially. Thies ensures that the communication terminal with a good communication state and a high possibility that the signal has been transmitted properly is selected and that the reliable and high-quality audio signal is reproduced. A description will be given of a process for determining one communication terminal as the prioritized terminal from the multiple communication terminals.

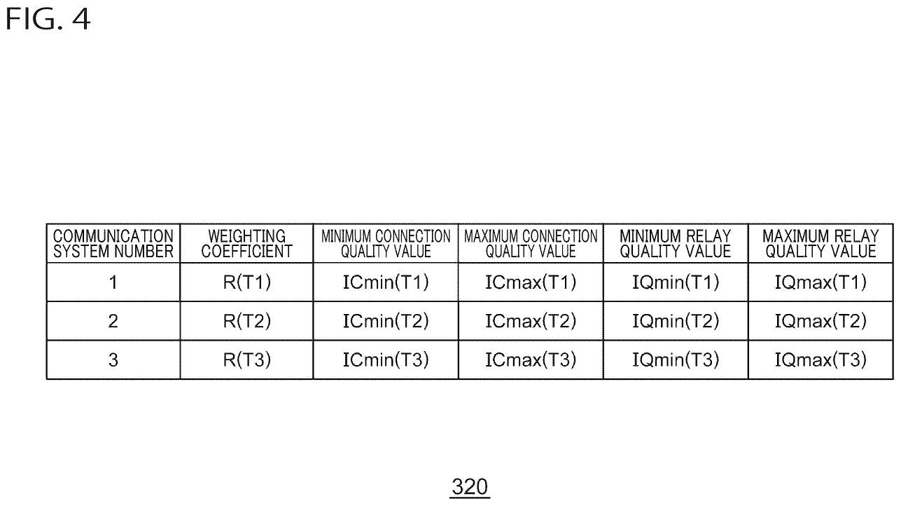

FIG. 4 shows a data structure of a parameter table stored in the storage 320. The communication system number (Tn) denotes a number used to identify a wireless communication system or a wireless communication scheme. For example, the first wireless communication scheme is denoted by T1 and the second wireless communication scheme is denoted by T2. The weighting coefficient R(Tn) represents, in the form of a coefficient, which wireless communication scheme is prioritized among multiple wireless communication schemes. The greater the value of the weighting coefficient R(Tn), the higher the priority.

“Minimum connection quality value” ICmin (Tn) denotes the ICn quality required for use and indicates that communication is not possible at or below this level. “Maximum connection quality value” ICmax (Tn) denotes the ICn quality sufficient for use and indicates that the communication situation remains good at or beyond this level. “Minimum relay quality value” IQmin (Tn) denotes the IQn quality required for use and indicates that communication is not possible at or below this level. “Maximum relay quality value” IQmax (Tn) denotes the IQn quality sufficient for use and indicates that the communication situation remains good at or beyond this level. These values are predetermined according to the usage environment and the user's policy.

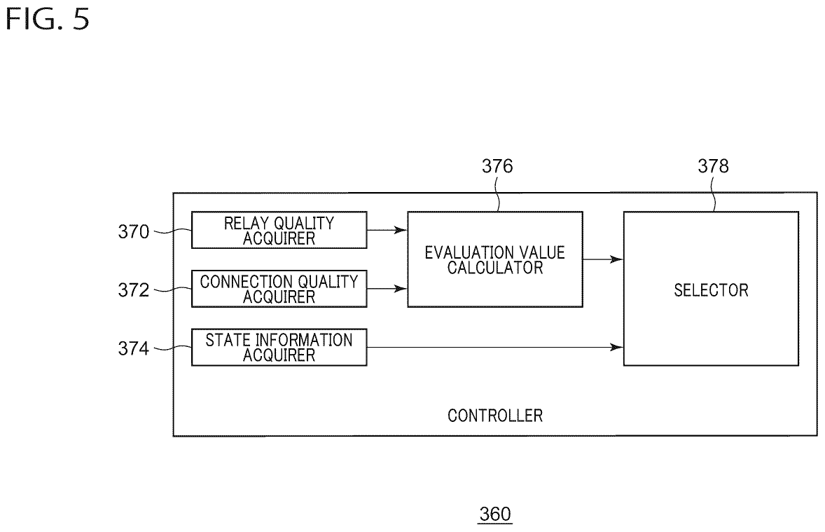

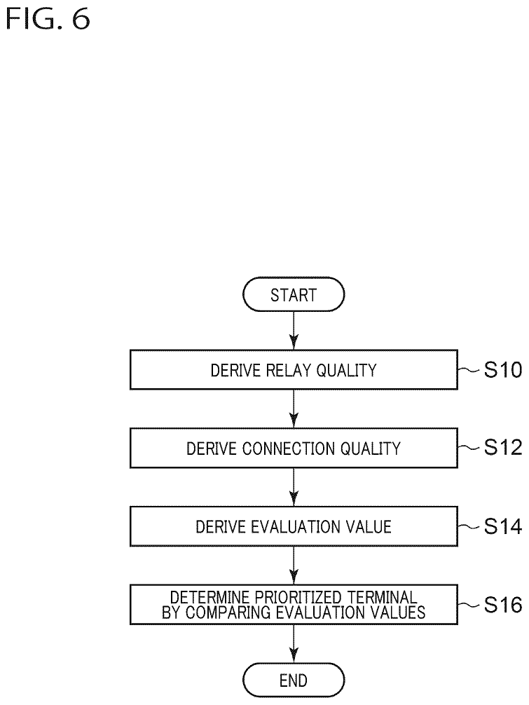

FIG. 5 shows a configuration of the controller 360. The controller 360 includes a relay quality acquirer 370, a connection quality acquirer 372, a state information acquirer 374, an evaluation value calculator 376, and a selector 378. FIG. 6 is a flowchart showing a sequence of steps performed by the controller 360 to determine a prioritized terminal. The controller 360 derives the relay quality (S10). The controller 360 derives the connection quality (S12). The controller 360 derives the evaluation value (S14). The controller 360 determines the prioritized terminal by comparing the evaluation values (S16). In the following, (2-1) derivation of relay quality, (2-2) derivation of connection quality, (2-3) derivation of evaluation value, and (2-4) determination of prioritized terminal will be explained in the stated order.

### (2-1) Derivation of Relay Quality

The relay quality acquirer 370 acquires the quality information IQn from the storage 320 and also acquires IQmin (Tn) and IQmax (Tn) from the storage 320. Based on these values, the relay quality acquirer 370 calculates the relay quality On as follows.

Qn=(IQn−IQmin(Tn))/(IQmax(Tn)−IQmin(Tn))

where Qn=0 when On≤0, and Qn=1 when 1≤Qn.

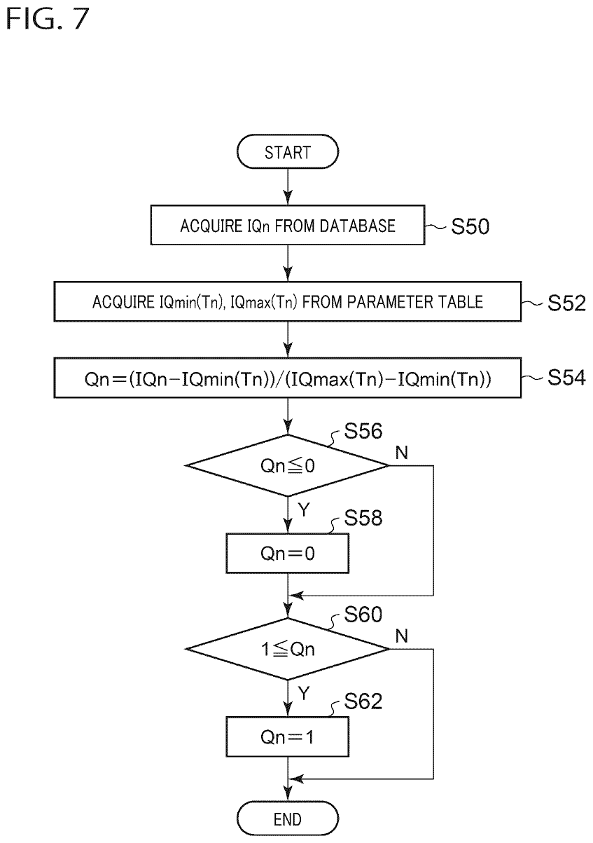

The process in the relay quality acquirer 370 will be described in the following. FIG. 7 is a flowchart showing a sequence of steps performed by the controller 360 to derive a relay quality. The relay quality acquirer 370 acquires IQn from the database (S50) and acquires IQmin (Tn) and IQmax (Tn) from the parameter table (S52). The relay quality acquirer 370 calculates Qn=(IQn−IQmin(Tn))/(IQmax(Tn)−IQmin(Tn)) (S54). The relay quality acquirer 370 assumes that Qn=0 (S58) when Qn≤0 (Y in S56). The relay quality acquirer 370 skips step 58 when Qn≤0 does not hold (N in S56). The relay quality acquirer 370 assumes that Qn=1 (S62) when 1≤Qn (Y in S60). The relay quality acquirer 370 skips step 62 when 1≤Qn does not hold (N in S60). Reference is made back to FIG. 5.

For example, it will be assumed, given that the quality information represents radio field strength, that IQmin (Tn)=95 dBm, IQmax (Tn)=125 dBm. This results in Qn=(IQn−95)/(125−95). When IQn is equal to or less than 95 dBm, Qn is equal to or less than 0, and so Qn is assumed to be 0. Further, when IQn is equal to or more than 125 dBm, Qn is equal to or more than 1, and so Qn is assumed to be 1.

When the radio field strength is displayed in the form of the number of antenna icons 0-4 in the second communication terminal 220, for example, these presentations are equated with IQ=1-4. Further, IQmin=1 (it is determined that communication is not possible in the case of one antenna icon or fewer), and IQmax=3 (when there are three or more antenna icons, communication can be performed properly regardless of the situation). Thus, Qn is calculated such that Qn=(IQ−1)/(3−1). When there is one antenna icon or fewer, Qn will be equal to or less than 0, and so Qn is assumed to be 0. Further, when there are more than 3 antenna icons, Qn will be equal to or more than 1, and so Qn is assumed to be 1. In this way, the relay quality acquirer 370 acquires the communication state between the first base station apparatus 110 and the first communication terminal 120 as the first relay quality information Q1 and also acquires the communication state between the second base station apparatus 210 and the second communication terminal 220 as the second relay quality information Q2.

### (2-2) Derivation of Connection Quality

The connection quality acquirer 372 acquires the quality information ICn from the storage 320 and also acquires ICmin (Tn) and ICmax (Tn) from the storage 320. Based on these values, the connection quality acquirer 372 calculates the connection quality Cn as follows.

$$Cn = ( ICn - ICmin ( Tn ) ) / ( ICmax ( Tn ) - ICmin ( Tn ) )$$

where it is assumed that Cn=0 when Cn≤0, and it is assumed that Cn=1 when 1≤Cn.

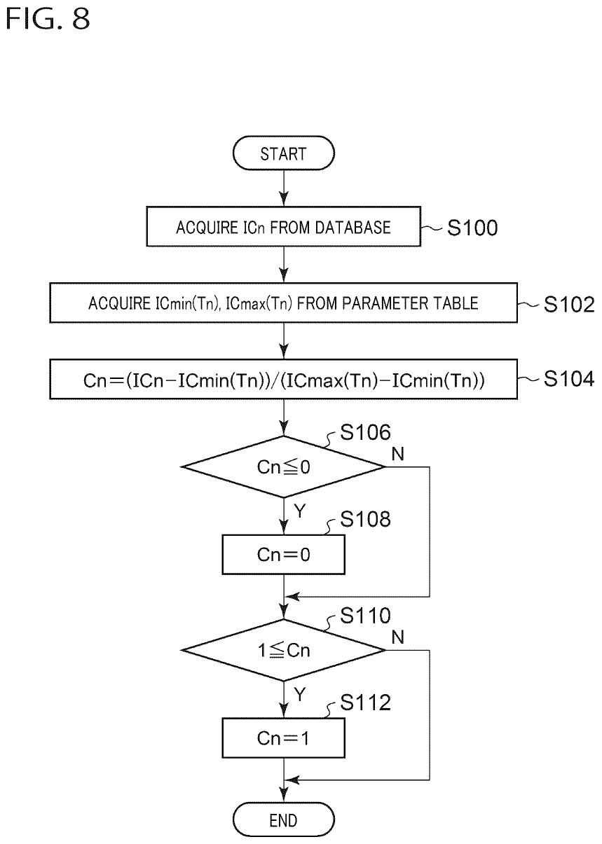

The process in the connection quality acquirer 372 is described below. FIG. 8 is a flow chart showing a sequence of steps procedure performed by the controller 360 to derive a connection quality. The connection quality acquirer 372 acquires ICn from the database (S100) and acquires ICmin (Tn) and ICmax (Tn) from the parameter table (S102). The connection quality acquirer 372 calculates Cn=(ICn−ICmin(Tn))/(ICmax(Tn)−ICmin(Tn)) (S104). The connection quality acquirer 372 assumes that Cn=0 (S108) when Cn≤0 (Y in S106). The connection quality acquirer 372 skips step 108 when Cn≤0 does not hold (N in S106). The connection quality acquirer 372 assumes that Cn=1 (S112) when 1≤Cn (Y in S110). The connection quality acquirer 372 skips step 112 when 1≤Cn does not hold (N in S110). Reference is made back to FIG. 5.

In this way, the connection quality acquirer 372 acquires the communication state between the first communication terminal 120 and the first communication module 312a as the first connection quality information C1 and also acquires the communication state between the second communication terminal 220 and the second communication module 312b as the second connection quality information C2.

### (2-3) Derivation of Evaluation Value

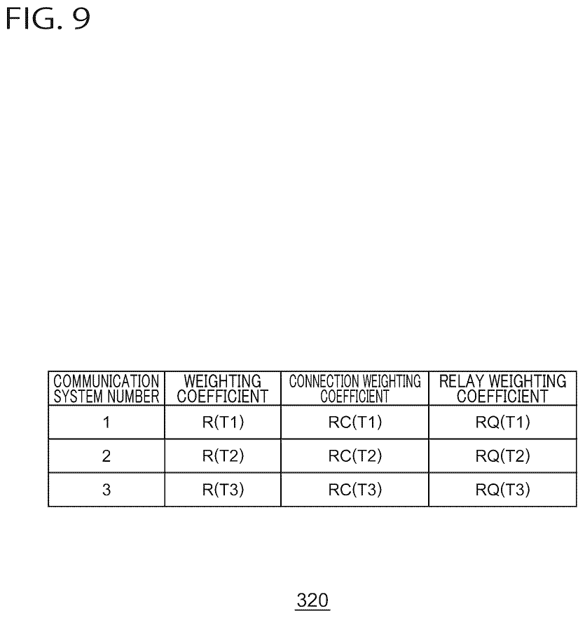

FIG. 9 shows another data structure of the parameter table stored in the storage 320. The parameter table shown in FIG. 4 stores the weighting coefficient R(Tn), but the parameter table shown in FIG. 9 additionally stores the connection weighting coefficient RC(Tn) and the relay weighting coefficient RQ(Tn) that represents the importance of connection and relay, respectively. In particular, the relay weighting coefficient RQ(Tn), as a conversion coefficient to make comparison between the first relay quality information Q1 and the second relay quality information Q2 on equal terms possible, is also referred to as the first evaluation coefficient RQ(T1) for the first wireless communication scheme and the second evaluation coefficient RQ(T2) for the second wireless communication system. Even when the first communication terminal is a business wireless equipment and the quality information on relay quality on the side of the first communication terminal is represented as the radio field strength in dBm, and the second communication terminal is a smartphone and the quality information on relay quality on the side of the second communication terminal is represented as the radio field strength indicated by the number of antenna icons, for example, it will be possible to evaluate and compare the quality on equal terms by introducing the relay weighting coefficient RQ(Tn). In an alternative configuration, even when the first communication terminal is a business wireless equipment and the quality information on relay quality on the side of the first communication terminal is represented as the radio field strength in dBm, and the second communication terminal is a smartphone and the quality information on relay quality on the side of the second communication terminal is represented as the radio field strength in dBm with a potential numerical range different from that of the side of first communication terminal, for example, it will be possible to evaluate and compare the quality on equal terms by introducing the relay weighting coefficient RQ(Tn). In a still alternative configuration, even when the first communication terminal is a business wireless equipment and the quality information on relay quality on the side of the first communication terminal is represented as the radio field strength indicated by the number of antenna icons, and the second communication terminal is a smartphone and the quality information on relay quality on the side of the second communication terminal is represented as the radio field strength indicated by the number of antenna icons different from that of the side of the first communication terminal, for example, it will be possible to evaluate and compare the quality on equal terms by introducing the relay weighting coefficient RQ(Tn). Further, the connection weighting coefficient RC(Tn), as a conversion coefficient to make comparison between the first connection quality information C1 on the side of the first communication terminal and the second connection quality information C2 on side of the second communication terminal possible, is also referred to as the third evaluation coefficient RC(T1) on the side of the first communication terminal and the fourth evaluation coefficient RC(T2) on the side of the second communication terminal. Even when the first communication terminal is a business wireless equipment and the quality information on connection quality on the side of the first communication terminal is represented as the radio field strength in dBm, and the second communication terminal is a smartphone and the quality information on connection quality on the side of the second communication terminal is represented as the radio field strength indicated by the number of antenna icons, for example, it will be possible to evaluate and compare the quality on equal terms by introducing the connection weighting coefficient RC(Tn). In an alternative configuration, even when the first communication terminal is a business wireless equipment and the quality information on connection quality on the side of the first communication terminal is represented as the radio field strength in dBm, and the second communication terminal is a smartphone and the quality information on connection quality on the side of the second communication terminal is represented as the radio field strength in dBm with a numerical range different from that of the side of first communication terminal, for example, it will be possible to evaluate and compare the quality on equal terms by introducing the connection weighting coefficient RC(Tn). In a still alternative configuration, even when the first communication terminal is a business wireless equipment and the quality information on connection quality on the side of the first communication terminal is represented as the radio field strength indicated by the number of antenna icons, and the second communication terminal is a smartphone and the quality information on connection quality on the side of the second communication terminal is represented as the radio field strength indicated by the number of antenna icons different from that of the side of the first communication terminal, for example, it will be possible to evaluate and compare the quality on equal terms by introducing the connection weighting coefficient RC(Tn). Further, the weighting coefficient R(Tn) is also referred to as the fifth evaluation coefficient R(T1) on the side of the first communication terminal and the sixth evaluation coefficient R(T2) on the side of the second communication terminal. These first through sixth evaluation coefficients can be said to be evaluation coefficients to cover the difference in quality information between the first communication terminal and the second communication terminal or the difference in importance between terminals. Reference is made back to FIG. 5.

The evaluation value calculator 376 calculates the evaluation value Vn as follows.

$$Vn = R ( Tn ) \times \{ RC ( Tn ) \times Cn + RQ ( Tn ) \times Qn \}$$

When either Qn and Cn is 0, it is assumed that Vn=0 because communication is not possible. Further, in the case of making an evaluation by using only the relay quality Qn without using the connection quality Cn, Vn may be calculated by assuming that RC(Tn)=0, Vn may be calculated by omitting multiplication by Cn. Further, when the weighting coefficients R(Tn), RC(Tn), and RQ(Tn), calculated such that the coefficient is normalized with reference to one of the subjects of comparison, are stored, the multiplication process may be omitted because the weighting coefficient of the referenced subject is 1. When the first wireless communication scheme is denoted by T1 and the second wireless communication scheme is denoted by T2, and the weighting coefficients, calculated such that the coefficient is normalized with reference to the T1 side, are stored, for example, R(T1)/R(T1)=1, RC(T1)/RC(T1)=1, and RQ(T1)/RQ(T1)=1 so that the multiplication process may be omitted to simplify the process by assuming that V1=C1+Q1. With regard to the coefficient on T2 side, the process may be simplified by calculating and storing R(T2)/R(T1), RC(T2)/RC(T1), and RQ(T2)/RQ(T1) in advance and using the stored values to calculate the evaluation value Vn. Further, when weighting by R(Tn) is not performed, i.e., when R(Tn)=1, multiplication by R(Tn) may be omitted to simplify the process by calculating

$$Vn = RC ( Tn ) \times Cn + RQ ( Tn ) \times Qn .$$

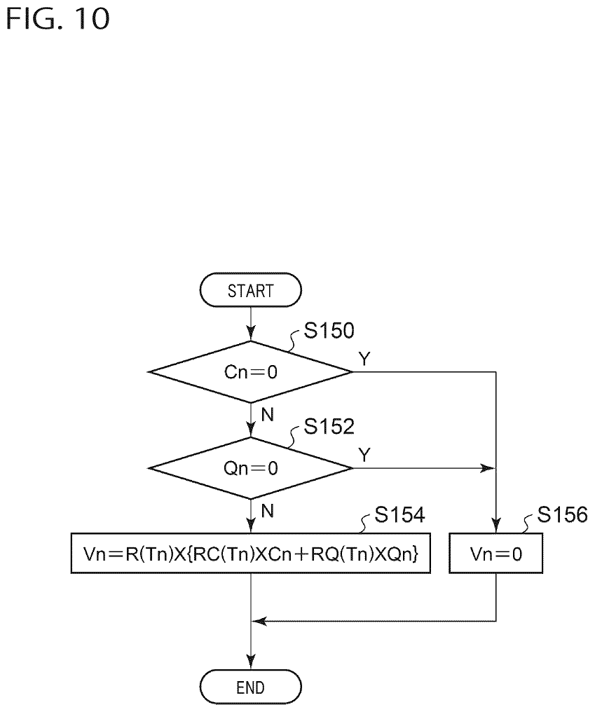

The process in the evaluation value calculator 376 is as described in the following. FIG. 10 is a flowchart showing a sequence of steps performed by the controller 360 to derive the evaluation value. When Cn=0 does not hold (N in S150) and Qn=0 does not hold (N in S152), the evaluation value calculator 376 calculates Vn=R(Tn)×{RC(Tn)×Cn+RQ(Tn)×Qn} (S154). When Cn=0 (Y in S150) or when Qn=0 (Y in S152), the evaluation value calculator 376 assumes that Vn=0 (S156). Reference is made back to FIG. 5. In this way, the evaluation value calculator 376 calculates the first evaluation value V1 based on the first connection quality information C1, the first relay quality information Q1, and the first evaluation coefficient and calculates the second evaluation value V2 based on the second connection quality information C2, the second relay quality information Q2, and the second evaluation coefficient.

To simplify the process, the evaluation value calculator 376 may calculate the evaluation value Vn as follows.

$$Vn = R \times Qn \times Cn$$

In the case of making an evaluation by using only the relay quality Qn without using the connection quality Cn, Vn may be calculated by assuming that Cn=1, or Vn may be calculated by omitting multiplication by Cn. Further, when the weighting coefficient R(Tn), calculated such that the coefficient is normalized with reference to one of the subjects of comparison, is stored, the multiplication process may be omitted because the weighting coefficient of the referenced subject is 1. When the first wireless communication scheme is denoted by T1 and the second wireless communication scheme is denoted by T2, and the weighting coefficients, calculated such that the coefficient is normalized with reference to the T1 side, are stored, R(T1)/R(T1)=1 so that multiplication by R(T1) may be omitted to simplify the process by assuming that V1=Q1×C1. With regard to the coefficient on the T2 side, the process may be simplified by calculating and storing R(T2)/R(T1) in advance and using the stored value to calculate the evaluation value Vn. Further, when weighting by R(Tn) is not performed, i.e., when R(Tn)=1, multiplication by R(Tn) may be omitted to simplify the process by calculating

$$Vn = Qn \times Cn .$$

Further, the evaluation value calculator 376 may calculate the evaluation value Vn as follows. When, in the exemplary embodiment, the quality information obtained from the first communication terminal and that of the second communication terminal in communication connection with the communication apparatus 300 according to the third wireless communication scheme have the same representation format (e.g., when the quality information is represented as the radio field strength and the unit of radio field strength is dB on both sides, and when the potential ranges of the radio field strength are also the same), RC(T1) and RC(T2) in the evaluation formula Vn=R(Tn)×{RC(Tn)×Cn+RQ(Tn)×Qn} may both be assumed to be 1, denoting the side of the first communication terminal by T1 and the side of the second communication terminal by T2. Further, when weighting by R(Tn) is not performed in the exemplary embodiment, i.e., when R(Tn)=1, the evaluation formula Vn can be transformed into Vn=Cn+RQ(Tn)×Qn. Denoting the side of the first communication terminal by T1 and the second communication terminal side by T2, the evaluation formula will be as follows.

$$V 1 = C 1 + RQ ( T 1 ) \times Q 1$$

$$V 2 = C 2 + RQ ( T 2 ) \times Q 2$$

RQ(T1) and RQ(T2) in the above formulas may be stored in the parameter table in the storage 320, and the evaluation value calculator 376 may use the parameter when calculating the evaluation value Vn.

When the coefficient is normalized with reference to the T1 side and stored accordingly, for example, the evaluation formula Vn=Cn+RQ(Tn)×Qn transformed as described above can be transformed into V1=C1+Q1 because RQ(T1)/RQ(T1)=1. By transforming the formula in this way, multiplication by RQ(T1) may be omitted to simplify the process. The process may be simplified by transforming the formula into V2=C2+RQ(T2)/RQ(T1)×Q2, and, with regard to the coefficient on the T2 side, calculating and storing the RQ(T2)/RQ(T1) in advance and using the stored values to calculate the evaluation value Vn. In other words, the parameter table in the storage 320 may store, as the evaluation coefficient, at least one result of calculation of RQ(T2)/RQ(T1), and the coefficient may be used to calculate the evaluation value Vn. Further, the combination of the connection quality Cn and the relay quality On may be referred to as the nth route quality information. In other words, the nth route quality information includes, as elements of the nth route quality information, two types of elements including the connection quality Cn and the relay quality Qn. The evaluation value Vn is calculated by using the evaluation coefficient corresponding to the element of the nth route quality information stored, multiplying the element of the nth route quality information and the evaluation coefficient corresponding to the element of the nth route quality information, and adding the elements of the nth route quality information multiplied by the corresponding evaluation coefficients.

For evaluation according to

$$V 1 = C 1 + Q 1 ,$$

$$V 2 = C 2 + RQ ( T 2 ) / RQ ( T 1 ) \times Q 2$$

using only the relay quality Qn and without using the connection quality Cn, Vn may be calculated by assuming that Cn=0. With regard to the coefficient on the T2 side, the process may be simplified by calculating and storing RQ(T2)/RQ(T1) in advance and using the stored value to calculate the evaluation value Vn. In other words, the parameter table in the storage 320 may store, as the evaluation coefficient, at least one result of calculation of RQ(T2)/RQ(T1), and the parameter may be used to calculate the evaluation value Vn.

### (2-4) Determination of Prioritized Terminal

The selector 378 compares multiple evaluation values and selects the communication terminal with the greater evaluation value as the prioritized terminal. To describe it specifically, the selector 378 compares the first evaluation value V1 with the second evaluation value V2 and selects the first communication terminal 120 as the prioritized terminal when the first evaluation value V1 is greater than the second evaluation value V2. On the other hand, the selector 378 selects the second communication terminal 220 as the prioritized terminal when the second evaluation value V2 is greater than the first evaluation value V1. When the first evaluation value V1 and the second evaluation value V2 are identical, or when the difference between the first evaluation value V1 and the second evaluation value V2 is equal to or less than a predetermined value, the first communication terminal 120 or the second communication terminal 220 may be selected according to a predetermined arrangement.

When multiple evaluation values (e.g., the first evaluation value V1 and the second evaluation value V2) are identical or the difference between the first evaluation value V1 and the second evaluation value V2 is equal or less than the predetermined value, the following operation may be performed. The state information acquirer 374 acquires the state information on each communication terminal from the database in the storage 320. For example, the state information acquirer 374 acquires the state information on the first communication terminal 120 (hereinafter referred to as “first state information”) and the state information on the second communication terminal 220 (hereinafter referred to as “second state information”). The state information on the communication terminal includes, for example, battery level and sound quality information. The state information may include at least one of power saving mode information, predicted available time, communication type, communication delay time, and communication packet loss rate.

When it is determined that the first evaluation value V1 and the second evaluation value V2 are identical or the magnitude of the difference between the first evaluation value V1 and the second evaluation value V2 is equal to or less than the predetermined value and that it is determined that one of the first communication terminal 120 and the second communication terminal 220 cannot be selected, the selector 378 selects one of the first communication terminal 120 and the second communication terminal 220 based on the first state information and the second state information. The selector 378 selects the communication terminal with a higher battery level or the communication terminal with a higher sound quality level.

### (3) Transmission Process

When the PTT button 330 of the communication apparatus 300 is pressed down by the user, the controller 360 checks whether a communication terminal that is connected to the communication module 312 and can communicate with the base station apparatus is found. When only one communication terminal is found, the controller 360 determines to use the communication module 312 connected to the communication terminal. For example, the controller 360 determines to use the first communication module 312a when only the first communication terminal 120 is found and determines to use the second communication module 312b when only the second communication terminal 220 is found.

If multiple communication terminals are found (e. g., when the first communication terminal 120 and the second communication terminal 220 are found), the controller 360 selects the prioritized terminal that has already been determined. For example, the controller 360 selects the first communication terminal 120 when the first communication terminal 120 is the prioritized terminal and selects the second communication terminal 220 when the second communication terminal 220 is the prioritized terminal.

When the controller 360 selects the communication terminal, the controller 360 receives the audio signal from the microphone 340. The controller 360 generates a digital audio signal (hereinafter also referred to as “audio signal”) by converting the audio signal from an analog signal to a digital signal. The controller 360 outputs the audio signal to the communication module 312 connected to the selected communication terminal. The communication module 312 transmits the audio signal to the communication terminal.

When the communication module 312 cannot connect to the prioritized terminal, or when the prioritized terminal cannot communicate with the base station apparatus, the controller 360 selects a communication terminal that is not the prioritized terminal. In that process, the controller 360 outputs the audio signal to the communication module 312 connected to the selected communication terminal. Further to the above description, the controller 360 may add header information to the audio signal. The communication system ID of the wireless communication system, including the communication terminal selected for transmission, is appended to the header information.

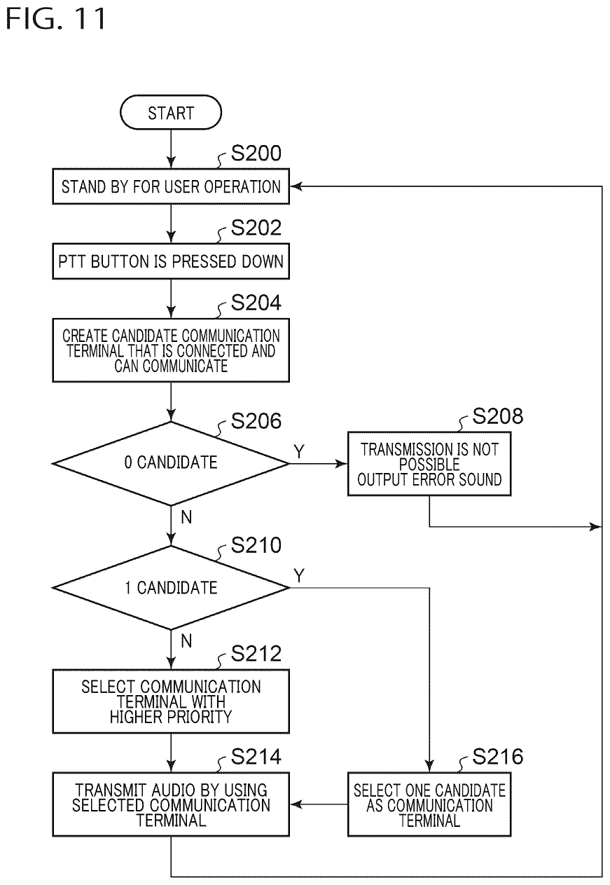

FIG. 11 is a flowchart showing a sequence of steps for transmission by the communication apparatus 300. The PTT button 330 stands by for a user operation (S200). The PTT button 330 is pressed down (S202). The controller 360 creates a candidate communication terminal that is connected to and can communicate with the communication module 312 (S204). When the number of candidates is “0” (Y in S206), the controller 360 determines that transmission is impossible, outputs an error sound from the speaker 350 (S208), and returns to step 200.

When the number of candidates is not “0” (N in S206) and is not “1” (N in S210), the controller 360 selects the communication terminal with a high priority (S212), then transmits an audio signal by using the selected communication terminal (S214) before returning to step 200. When the number of candidates is “1” (Y in S210), the controller 360 selects one candidate as the communication terminal (S216), then transmits an audio signal by using the selected communication terminal (S214) before returning to step 200.

### (4) Reception Process

Each of the plurality communication modules 312 in the communication apparatus 300 receives the audio signal from the communication terminal. The controller 360 does not reproduce all of the audio signals received by the communication modules 312 but selects and reproduces one of the multiple audio signals.

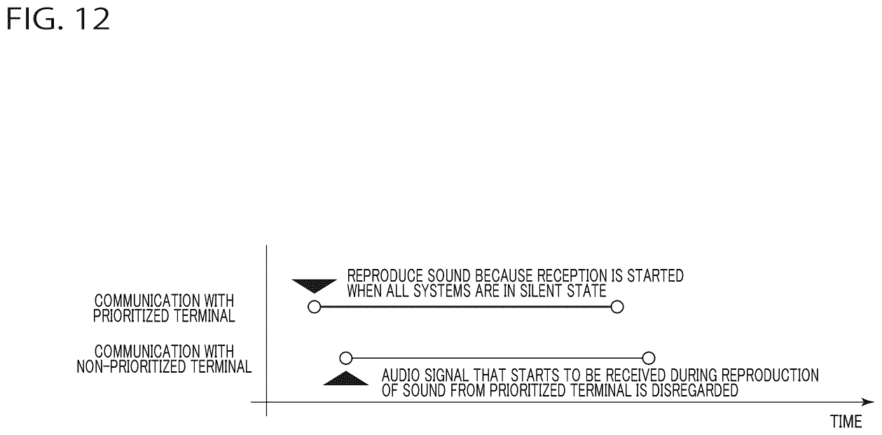

FIG. 12 shows an overview of a reception process by the communication apparatus 300. The horizontal axis represents time. Further, the upper row indicates communication with the prioritized terminal, and the lower row indicates communication with the communication terminal that is not the prioritized terminal (hereinafter referred to as “non-prioritized terminal”). It is assumed here that the audio signal from the prioritized terminal is received before the audio signal from the non-prioritized terminal. The communicator 310 of the communication apparatus 300, in a state of not receiving the audio signal from the prioritized terminal or the audio signal from the non-prioritized terminal, starts receiving the audio signal from the prioritized terminal and does not start receiving the audio signal from the non-prioritized terminal. The controller 360 controls the audio signal from the prioritized terminal to be reproduced when the audio signal from the prioritized terminal is in an audible state. The reproduced sound is output from the speaker 350. Even when the communicator 310 starts receiving the audio signal from the non-prioritized terminal while reproducing the audio signal from the prioritized terminal, the controller 360 does not reproduce the audio signal from the non-prioritized terminal.

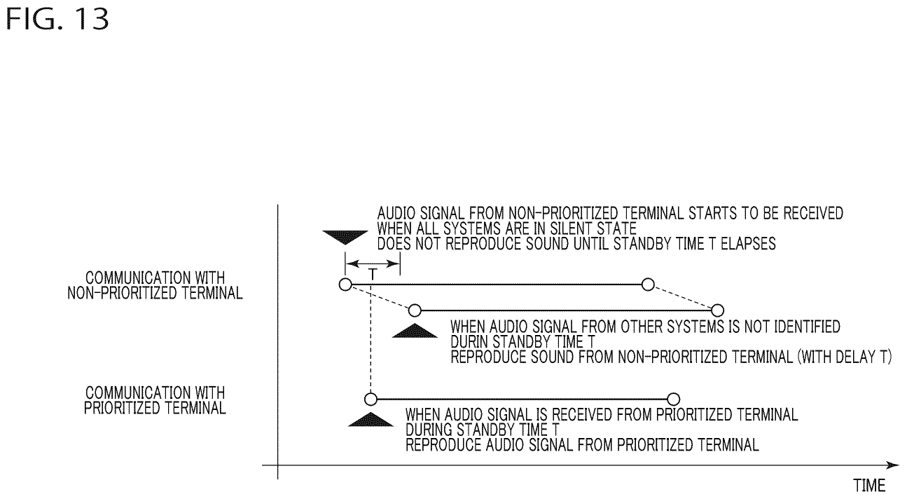

FIG. 13 shows an overview of another reception process by the communication apparatus 300. The horizontal axis represents time. Further, the upper row indicates communication with the non-prioritized terminal, and the lower row indicates communication with the prioritized terminal. It is assumed here that the audio signal from the non-prioritized terminal is received before the audio signal from the prioritized terminal. The communicator 310 of the communication apparatus 300, in a state of not receiving the audio signal from the prioritized terminal or the audio signal from the non-prioritized terminal, starts receiving the audio signal from the non-prioritized terminal and does not start receiving the audio signal from the prioritized terminal.

The controller 360 presets a predetermined period of time (hereinafter referred to as “standby time”) T to wait for the reception of an audio signal from the prioritized terminal. The controller 360 controls the audio signal from the non-prioritized terminal to be reproduced when the audio signal from the prioritized terminal does not change from a silent state to an audible state within the standby time T since the audio signal from the non-prioritized terminal changes from a silent state to an audible state. In other words, the audio signal from the non-prioritized terminal is reproduced with a delay of the standby time T. Meanwhile, the controller 360 controls the audio signal from the prioritized terminal to be reproduced when the audio signal from the prioritized terminal changes from a silent state to an audible state within the standby time T since the audio signal from the non-prioritized terminal changes from a silent state to an audible state. Therefore, the audio signal from the non-prioritized terminal is not reproduced.

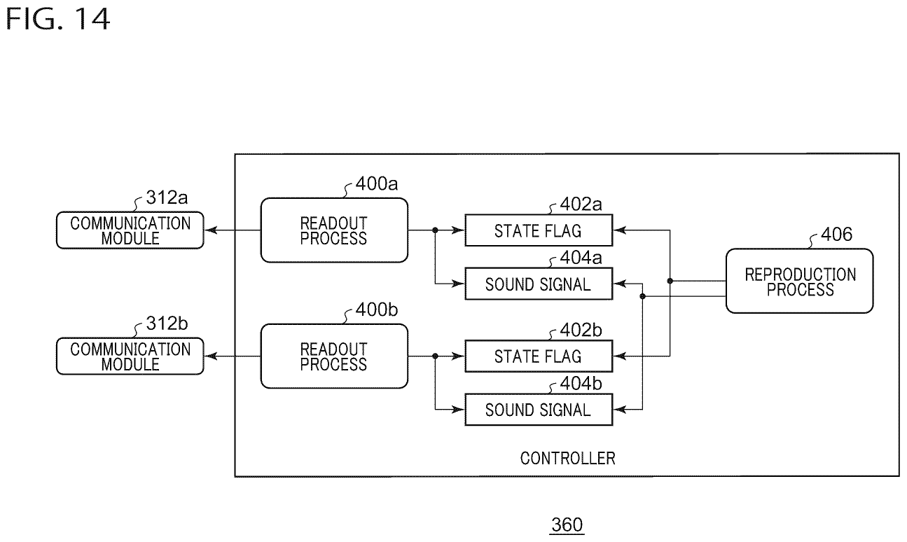

FIG. 14 shows another configuration of the controller 360. The controller 360 includes a first readout process 400a, a second readout process 400b, collectively referred to as a readout process 400, a first state FLAG 402a, a second state FLAG 402b, collectively referred to as a state FLAG 402, a first audio signal 404a, a second audio signal 404b, collectively referred to as an audio signal 404, and a reproduction process 406.

The first readout process 400a is connected to the first communication module 312a, checks the state of the first communication module 312a, and sets the checked state as the first state FLAG 402a. Further, the first readout process 400A reads out the first audio signal 404a from the first communication module 312a. The second readout process 400b is connected to the second communication module 312b, checks the state of the second communication module 312b, and sets the checked state as the second state FLAG 402b. Further, the second readout process 400b reads out the second audio signal 404b from the second communication module 312b. The reproduction process 406 checks the first state FLAG 402a and the second state FLAG 402b and reproduces either the first audio signal 404a or the second audio signal 404b accordingly. A unit of steps corresponding to the communication module 312 is also referred to as “node”.

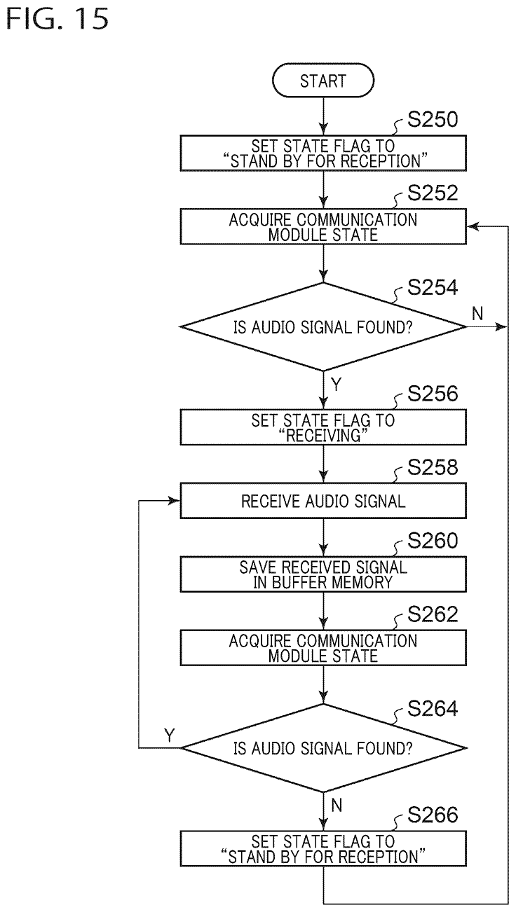

FIG. 15 is a flowchart showing a sequence of steps of the readout process 400. This process is performed for each node. The readout process 400 sets the state FLAG 402 to “stand by for reception” (S250). The readout process 400 acquires the state of the communication module 312 (S252). When an audio signal 404 (N in S254) is not found, the process returns to step 252. When an audio signal 404 is found (Y in S254), the readout process 400 sets the state FLAG 402 to “receiving” (S256). The readout process 400 receives the audio signal 404 (S258) and saves the audio signal 404 in a buffer memory (S260). The buffer memory is implemented by, for example, a FIFO (First In, First Out) memory. Alternatively, the buffer memory may be included in the storage 320. The readout process 400 acquires the state of the communication module 312 (S262). When an audio signal 404 is found (Y in S264), the process returns to step 258. When an audio signal 404 is not found (N in S264), the readout process 400 sets the state FLAG 402 to “stand by for reception” (S266) and returns to step 252. In this case, the state FLAG 402 is set or the process is changed depending on whether an audio signal 404 is found, but a command may be used to acquire whether the communication terminal is receiving, and the state FLAG 402 may be set or the operation may be changed accordingly.

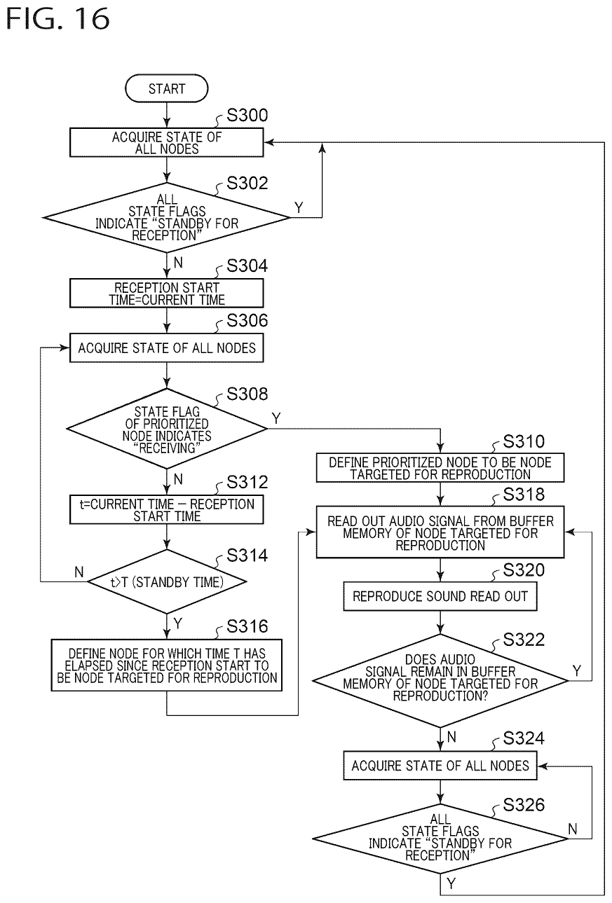

FIG. 16 is a flowchart showing a sequence of steps of the reproduction process 406. The reproduction process 406 acquires the state of all nodes (S300). When all state FLAGS 402 indicate “stand by for reception” (Y in S302), the process returns to step 300. When not all state flags 402 indicate “stand by for reception” (N in S302), the reproduction process 406 sets the reception start time at the current time (S304). The reproduction process 406 acquires the state of all nodes (S306).

When the state FLAG 402 of the node corresponding to the prioritized terminal (hereinafter referred to as “prioritized node”) indicates “receiving (Y in S308”), the reproduction process 406 defines that the prioritized node to be the node targeted for reproduction (hereinafter referred to as “reproduction target node”) (S310). When the state FLAG 402 of the prioritized node does not indicate “receiving” (N in S308), on the other hand, the reproduction process 406 sets t to be the current time—the reception start time (S312). When t>T does not hold (N in S314), the process returns to step 306. when t>T (Y in S314), the node for which time T has elapsed since the reception start time is defined to be the node targeted for reproduction (S316).

The reproduction process 406 reads out the audio signal 404 from the buffer memory of the node targeted for reproduction (S318) and reproduces the audio signal 404 thus read out (S320). When the audio signal 404 remains in the buffer memory of the node targeted for reproduction (Y in S322), the process returns to step 318. When the audio signal 404 does not remain in the buffer memory of the node targeted for reproduction (N in S322), the reproduction process 406 acquires the state of all nodes (S324). When not all state FLAGs 402 indicate “stand by for reception” (N in S326), the process returns to step 324. When all state FLAGs 402 indicate “stand by for reception” (Y in S326), the process returns to step 300.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

According to the exemplary embodiment, the first evaluation value is calculated from the first connection quality information, the first relay quality information, and the first evaluation coefficient for the first communication terminal that uses the first wireless communication method, and the second evaluation value is calculated from the second connection quality information, the second relay quality information, and the second evaluation coefficient for the second communication terminal that uses the second wireless communication method, so that the first evaluation value and the second evaluation value can be compared. Further, since the first and second evaluation values are compared, one of the first and second communication terminals can be selected as the prioritized terminal. Further, since one of the first and second communication terminals is selected as the prioritized terminal, the prioritized terminal can be used even when multiple communication terminals can be used. Further, since the prioritized terminal is used even when multiple communication terminals can be used, multiple communication terminals operated in multiple wireless communication systems can be used in an integrated manner. Further, since the prioritized terminal is used for transmission, multiple communication terminals operated in multiple wireless communication systems can be used in an integrated manner.

Further, the audio signal from the prioritized terminal is controlled to be reproduced when the audio signal from the prioritized terminal is in an audible state, and so multiple communication terminals operated in multiple wireless communication systems can be used in an integrated manner. Further, the audio signal from the prioritized terminal is controlled to be reproduced when the audio signal from the prioritized terminal changes from a silent state to an audible state within the predetermined period of time since the audio signal from the non-prioritized terminal changes from a silent state to an audible state, and so multiple communication terminals operated in multiple wireless communication systems can be used in an integrated manner. Further, the audio signal from the non-prioritized terminal is controlled to be reproduced when the audio signal from the prioritized terminal does not change from a silent state to an audible state within the predetermined period of time since the audio signal from the non-prioritized terminal changes from a silent state to an audible state, and so multiple communication terminals operated in multiple wireless communication systems can be used in an integrated manner.

The present disclosure has been described above based on an exemplary embodiment. In the exemplary embodiment, the audio signal has been described, but the exemplary embodiment also is applicable to an information signal such as a data signal. The exemplary embodiment is intended to be illustrative only, and it will be understood by those skilled in the art that various modifications to constituting elements and processes could be developed and that such modifications are also within the scope of the present disclosure.

The connection quality information and relay quality information used in the evaluation value calculator 376 of the exemplary embodiment are configured in such a manner that the connection quality information is acquired by the connection quality acquirer 372, and the relay quality information is acquired by the relay quality acquirer 370. Alternatively, a route quality acquirer provided with the functions of the connection quality acquirer 372 and the relay quality acquirer 370 may be provided, and the route quality information may be acquired by the route quality acquirer. The elements of the route quality information may include the connection quality information and the relay quality information. Further, the evaluation value calculator 376 in the exemplary embodiment calculates the evaluation value based on the connection quality information and the relay quality information. Alternatively, the evaluation value calculator 376 may, for example, calculate the evaluation value based on the relay quality information. For example, the evaluation value may be calculated by multiplying the relay quality information and the relay weighting coefficient. This corresponds to the case where only the relay quality information is included as the element of the route quality information. According to this variation, the calculation of the evaluation value can be simplified.

What is claimed is:

1. A communication apparatus adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, comprising:
a communicator that communicates with the first communication terminal and the second communication terminal;
a relay quality information acquirer that acquires, as first relay quality information, a communication state between the first base station apparatus and the first communication terminal and acquires, as second relay quality information, a communication state between the second base station apparatus and the second communication terminal;
a storage that stores an evaluation coefficient related to the first relay quality information and the second relay quality information;
an evaluation value calculator that calculates a first evaluation value and a second evaluation value based on the first relay quality information, the second relay quality information, and the evaluation coefficient stored in the storage;
a selector that selects, as a prioritized terminal, one of the first communication terminal and the second communication terminal by using the first evaluation value and the second evaluation value; and
a controller that controls an audio signal from the prioritized terminal to be reproduced when the audio signal from the prioritized terminal changes from a silent state to an audible state within a predetermined period of time since an audio signal from a non-prioritized terminal changes from a silent state to an audible state.

2. A communication apparatus adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, comprising:
a communicator that communicates with the first communication terminal and the second communication terminal by a third wireless communication scheme;
a relay quality information acquirer that acquires first route quality information from a communication state between the first communication terminal and the communicator and a communication state between the first base station apparatus and the first communication terminal and that acquires second route quality information from a communication state between the second communication terminal and the communicator and a communication state between the second base station apparatus and the second communication terminal;
a storage that stores an evaluation coefficient related to the first route quality information and the second route quality information;
an evaluation value calculator that calculates a first evaluation value and a second evaluation value based on the first route quality information, the second route quality information, and the evaluation coefficient stored in the storage;
a selector that selects, as a prioritized terminal, one of the first communication terminal and the second communication terminal by using the first evaluation value and the second evaluation value; and
a controller that controls an audio signal from the prioritized terminal to be reproduced when the audio signal from the prioritized terminal changes from a silent state to an audible state within a predetermined period of time since an audio signal from a non-prioritized terminal changes from a silent state to an audible state.

3. The communication apparatus according to claim 1,
wherein a weighting coefficient related to a wireless communication scheme is stored in the storage, and
the evaluation value calculator also uses the weighting coefficient stored in the storage when calculating the first evaluation value and the second evaluation value.

4. The communication apparatus according to claim 2,
wherein a weighting coefficient related to a wireless communication scheme is stored in the storage, and
wherein the evaluation value calculator also uses the weighting coefficient stored in the storage when calculating the first evaluation value and the second evaluation value.

5. The communication apparatus according to claim 1, further comprising:
a state information acquirer that acquires first state information related to the first communication terminal and second state information related to the second communication terminal,
wherein the selector selects the prioritized terminal based on a difference between the first evaluation value and the second evaluation value and selects one of the first communication terminal and the second communication terminal based on the first state information and the second state information when the difference is equal to or less than a predetermined value.

6. The communication apparatus according to claim 2, further comprising:
a state information acquirer that acquires first state information related to the first communication terminal and second state information related to the second communication terminal,
wherein the selector selects the prioritized terminal based on a difference between the first evaluation value and the second evaluation value and selects one of the first communication terminal and the second communication terminal based on the first state information and the second state information when the difference is equal to or less than a predetermined value.

7. A communication method adapted to communicate with each of a first communication terminal and a second communication terminal, the first communication terminal being configured for communication with a first base station apparatus by a first wireless communication scheme, and the second communication terminal being configured for communication with a second base station apparatus by a second wireless communication scheme, comprising:
acquiring, as first relay quality information, a communication state between the first base station apparatus and the first communication terminal and acquires, as second relay quality information, a communication state between the second base station apparatus and the second communication terminal,
wherein an evaluation coefficient related to the first relay quality information and the second relay quality information is stored in a storage, the method further comprising:
calculating a first evaluation value and a second evaluation value based on the first relay quality information, the second relay quality information, and the evaluation coefficient stored in the storage;
selecting, as a prioritized terminal, one of the first communication terminal and the second communication terminal by using the first evaluation value and the second evaluation value; and
controlling an audio signal from the prioritized terminal to be reproduced when the audio signal from the prioritized terminal changes from a silent state to an audible state within a predetermined period of time since an audio signal from a non-prioritized terminal changes from a silent state to an audible state.
